(19) United States
(12) Patent Application Publication
(10) Pub. No.: US 2022/0394170 A1
(43) Pub. Date: Dec. 8, 2022

(54) Remotely Assisted Modular Video Production Kit

(71) Applicant: Yukihiro Uemura, Martinez, CA (US)

(72) Inventor: Yukihiro Uemura, Martinez, CA (US)

(21) Appl. No.: 17/741,883

(22) Filed: May 11, 2022

Related U.S. Application Data
(60) Provisional application No. 63/197,249, filed on Jun. 4, 2021.

(51) Int. Cl. H04N 5/232; H04N 5/225; G03B 17/56

(52) U.S. Cl. CPC H04N 5/23206; H04N 5/2251; G03B 17/561

(57) ABSTRACT

A remotely controllable modular video production kit over a data network has a hinged case having a case bottom, a case top, a case handle, and a case latch operable to open and close the case, a video production camera mounted to a tripod head assembly, in turn mounted to a mounting plate secured against the back wall of the case top, a video monitor mounted to the video production camera by an extension boom arm, a computer processing unit (CPU) disposed within the case bottom within a compartment provided therein for the purpose, a production light source mounted to the mounting plate against the back wall of the case top, a network modem connected to the CPU, and a power supply disposed within the compartment formed in the case bottom, the power supply including a power on power off switch.

### CROSS-REFERENCE TO RELATED DOCUMENTS

The present invention claims priority to a U.S. provisional patent application serial number 63/197,249 entitled PROFESSIONAL VIDEO/AUDIO PRODUCTION KIT WITH REMOTE CREW ASSISTANCE, filed on Jun. 4, 2021 disclosure of which is included herein at least by reference.

### BACKGROUND OF THE INVENTION

### 1. Field of the Invention

The present invention relates to the field of professional video and audio production and pertains particularly to methods and apparatus for remotely assisting a video production film crew member from a remote office in real time.

### 2. Discussion of the State of the Art

In the arts of video film and audio production, film crew members typically require a great amount of training to operate professional video/audio cameras and lighting equipment before they may function adequately in a competitive production environment including real time production with live or near live streaming. With the advent of newer computer-aided video cameras, audio recorders, and lighting equipment, many production operators are able to create their own video productions with less training and support. Smaller power saving components required for video production may be integrated into cased products that may be easily be transported and set up on site; however, all of the adjustment features for fidelity, video quality, angle capturing, and correct lighting must still be navigated by the operator. A challenge remains in such a competitive environment in that, regardless of how technically superior the video, lighting, and sound equipment may be, better productions will be those where the operator had better knowledge of the nuances of video/sound quality, lighting, and camera angles. It has occurred to the inventor that a video producer having little or no experience with video production equipment may be advised and/or assisted from a remote location over a network

Therefore, what is clearly needed is a professional video/audio production kit with live on-demand or scheduled remote crew assistance.

### BRIEF SUMMARY OF THE INVENTION

According to an embodiment of the present invention, a video production kit is provided including a hinged case having a case bottom, a case top, a case handle, and a case latch operable to open and close the case, the case bottom and case top each having an internal volume defined by a length dimension, a width dimension, and a depth dimension, a video production camera mounted to a tripod head assembly, in turn mounted to a mounting plate secured against the back wall of the case top, a video monitor mounted to the video production camera by an extension boom arm, a computer processing unit (CPU) disposed within the case bottom within a compartment provided therein for the purpose, a production light source mounted to the mounting plate against the back wall of the case top, at least one microphone connected to an audio input port, at least one network modem connected to the CPU, and a power supply disposed within the compartment formed in the case bottom, the power supply including a power-on/power-off switch, characterized in that a remote network-connected service may by invitation request from an operator of the modular video production kit, access the modular video production kit over the data network, communicate with the operator of the modular video production kit, make remote adjustments to electronic components of the modular video production kit in set up and in use, and may receive video and audio recorded from the modular video production kit for the purpose of remote processing and publishing.

In one embodiment, the modular video production kit of claim 1 further includes an electronic switcher board connected to the CPU, the switcher board having multiple camera source inputs and video feed outputs and having operable function keys for controlling switching between the multiple camera sources while recording. In one embodiment, the video monitor is adapted to function as a user interface device for interaction with a remote individual or a remote crew when the operator has the camera powered on and is connected to the data network. In one embodiment, the modular video production kit further includes a gas strut mounted to a sidewall of the case top at one end and to the front sidewall on the case bottom at the other end, the gas strut adapted to hold the hinged case open at a desired angle.

In one embodiment, the modular video production kit further includes one or more hinge locks adapted to hold the hinged case open at a desired angle. In one embodiment, the modular video production kit further includes a rechargeable battery. In one embodiment, the power supply is plugged into an alternating current (AC) outlet for power. In one embodiment, the modem the modem is adapted as a wireless modem having access to the data network through a wireless network and wherein the data network accessed is the Internet network. In one embodiment, the modular video production kit further includes an Ethernet port and cable for accessing the data network via an Ethernet network connection.

In one embodiment, the modular video production kit further includes a portable wireless router for creating a Wi-Fi hotspot through which the data network may be accessed. In one embodiment, the tripod head assembly includes three operable knobs for adjusting camera position relative to at least tilt, angle, and pan, the knobs controlling the head component of the assembly adapted as a mounting platform for the video production camera. In one embodiment, the at least one microphone is a high impedance unidirectional microphone. In one embodiment, the at least one microphone is high impedance omnidirectional microphone.

In one embodiment, the modular video production kit further includes a cinema adapter for mixing camera audio from a remote location on the network. In one embodiment, the modular video production kit further includes at least two extendable stabilization legs installed in the case bottom and adapted to be extended and locked to stabilize the hinged case on a flat surface. In one embodiment, communications between the remote crew and camera operator over the data network are brokered by a communications server connected to the data network. In one embodiment, remote assistance is provided through a subscription service on demand or by schedule.

In one embodiment, the act of connecting the production kit to the data network results in a request sent for remote assistance that is, by default, routed to a remote service agent station according to agent availability. In one embodiment, the video production created with assistance from a remote agent is recorded to a memory drive on the video production kit for later publication through the remote service that provided the remote assistance. In one embodiment, the video production created with assistance from a remote agent is streamed live to a publication channel through the remote service providing the remote assistance.

### BRIEF DESCRIPTION OF THE SEVERAL VIEWS OF THE DRAWINGS

FIG. 1 is an elevation view of a video production kit according to an embodiment of the present invention.

FIG. 2 is a top view of the video production kit of FIG. 1.

FIG. 3 is a disassembled view of the video production kit of FIG. 1 depicting basic components.

FIG. 4 is a perspective view of the tripod head assembly of the video production kit of FIG. 1.

FIG. 5 is a process flow chart depicting steps for remotely assisting a video production using the video production kit of FIG. 1.

FIG. 6 is an architectural view of a network bridging the video production kit of FIG. 1 to a remote crew controlling interface.

### DETAILED DESCRIPTION OF THE INVENTION

In various embodiments described in enabling detail herein, the inventor provides a unique video/audio production system and/or apparatus that allows a remote on demand assistant to help a local operator with camera controls and settings and production management in real time. The present video/audio production system and/or apparatus, and methods of using same are described using the following examples, which may describe more than one relevant embodiment falling within the scope of the production system and/or apparatus and methods of using same.

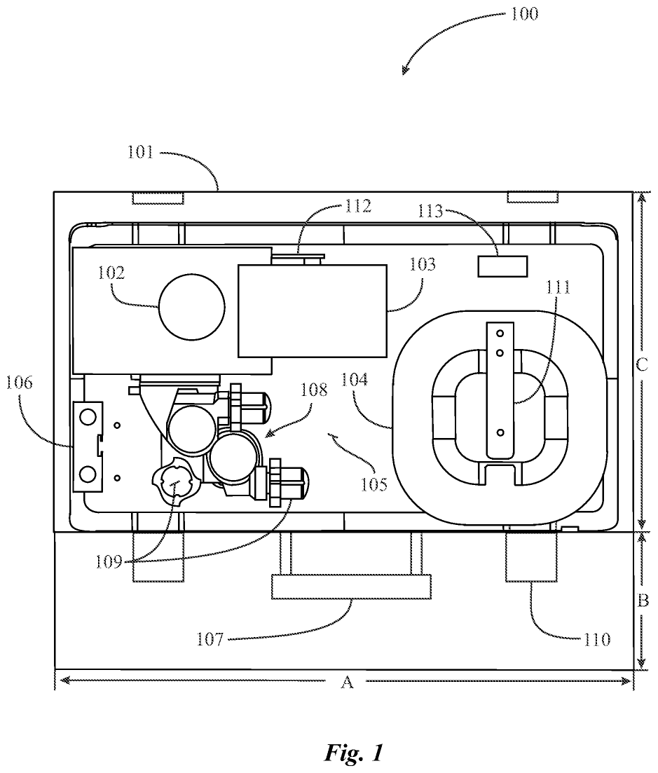

FIG. 1 is an elevation view of a video production kit 100 according to an embodiment of the present invention. Video production kit 100 is provided in the form of a hinged case that opens and closes. Video/audio production kit 100 hereinafter referred to as production kit 100 is, in this embodiment, enclosed in a hinged lightweight plastic carry case 101 when not in use. Case 101 may be fabricated of materials other than plastic so long as the material is light weight and durable. Carry case 101 may be latched and/or locked for security purposes when closed using latch components 110. Case 101 has a handle 107 for easy carry when the case is closed and latched and/or locked. When production kit 100 is being used, the operator unlatches and opens the case containing all of the kit components and accessories which may be stored or mounted therein and used.

Case 101 has an overall width A of about 22 inches. The bottom portion of case 101 has a height B of about 5 inches. In the open position with the top portion of case 101 vertical, the height C of the top portion of the case is about 14 inches. The kit components included with production kit 100 generally include camera components, audio recording components, lighting components, and a video monitor integrated with the case structure and or included within storage areas of the case structure to promote a fast and easy set up and adjustment of the equipment for a video production shoot. In one embodiment, a top component mounting plate 105 is provided and attached or otherwise fixed to the inside of the top lid of case 101 to receive and support case mounted components.

Production kit 100 includes a professional grade camera 102 having a pixel resolution of 4096 x 2060 or better. In a preferred embodiment, camera 102 is 4K cinema camera that is mountable within case 101 providing a 4000-pixel horizontal screen resolution (top quality) and a superior color depth with 12 bits resolution, which is improved over the 10-bit high definition (HD) capability. Camera 102 may be operated and professionally adjusted in real time remotely by a remote individual or crew in communication with the camera operator via an Ethernet connection or a wireless fidelity (Wi-Fi) hot spot provided with the electronics of the kit and useable if no Ethernet connection is available.

Production kit 100 includes a camera tripod head mechanism 108 for supporting camera 102 disposed just beneath the camera and integrated into case 101. Tripod mechanism 108 is adapted for achieving camera tilt, camera angle, and pan of camera 102. Tripod head mechanism 108 includes three mechanical adjustment knobs 109 for enabling an operator to adjust the position of camera 102 along an x, y, and z axis. Production kit 100 includes a monitor 103. Monitor 103 is disposed strategically just to the right of camera 102 looking into the camera and immediately adjacent thereto. Monitor 103 may be mounted to camera 102 via a horizontal swivel boom arm 112.

Monitor 103 is adapted to function as an operator interface device for interaction with a remote individual or a remote crew when the operator has the camera powered on and is connected (automatically) over a data network to a computing system or device with remote network access to the kit. In a preferred embodiment, the network connection is created between the production kit and the remote crew or individual crew member computing appliance or device once an operator of the production kit has connected video production kit 100 to a power source and an Ethernet network or other network access component and powers up the production kit by pressing a power button to boot up the computer-aided video production kit.

Production kit 100 may include at least one unidirectional or omnidirectional high impedance microphone (not illustrated) for recording audio and may also support wireless Lay wearable microphones that use wireless transmission to transmit the audio data to the production kit. In a preferred embodiment, a variety of microphone types may be used together or individually and are supported by a computing element of the production kit by way of port connections wired and wireless. Production kit 100 may include an audio controller device 106 depicted mounted to top plate 105 for adjusting the quality of audio.

Production kit 100 may include one or more lighting components such as a mounted lighting component 104 depicted herein as a primary light source mounted to plastic case 101 via a mounting fixture or bracket 111 and swivel 113. Light source 104 may be folded out from case 101 and directed toward a talent or other subject of the video shoot. Main lighting component 104 may be an Elgato™ Key Light Air illumination device. Light source 104 may be adjustable for position and angle, may be adjusted for various lighting color schemes, and may be controlled by the remote crew from a remote location over a network. Light source 104 is depicted in a folded position tucked against the case top of the video kit. Secondary lighting components may also be provided that mount directly to case 101 and may be stored in a compartment with or without other components. In one embodiment, lighting source 104 may be removed from the mounting hardware on case 101 and used with a different hardware as a tabletop light or a light mounted to a boom stand. Top mounting plate 105 may be fabricated of a lightweight metal like steel, sheet metal, or aluminum which takes up much of the footprint inside the top lid of case 101. It is noted herein that one or more pouches or compartments may be provided within the space of hinged case 101 for the purpose of storing components and accessory parts that may be used with the video production kit 101.

In a preferred embodiment, production kit 100 may be provided with a remote crew service which an operator may subscribe to as a service member when they purchase a kit. The camera operator may elect to receive on demand and scheduled online assistance with video production tasks including making minor camera adjustments, sound quality adjustments, lighting adjustments, teleprompter materials and control of delivery, microphone switching (more than one microphone), camera switching (multiple cameras), green screen operations (background dressing), video streaming, video broadcast, video editing/synchronizing, and recording to drive space for later publication.

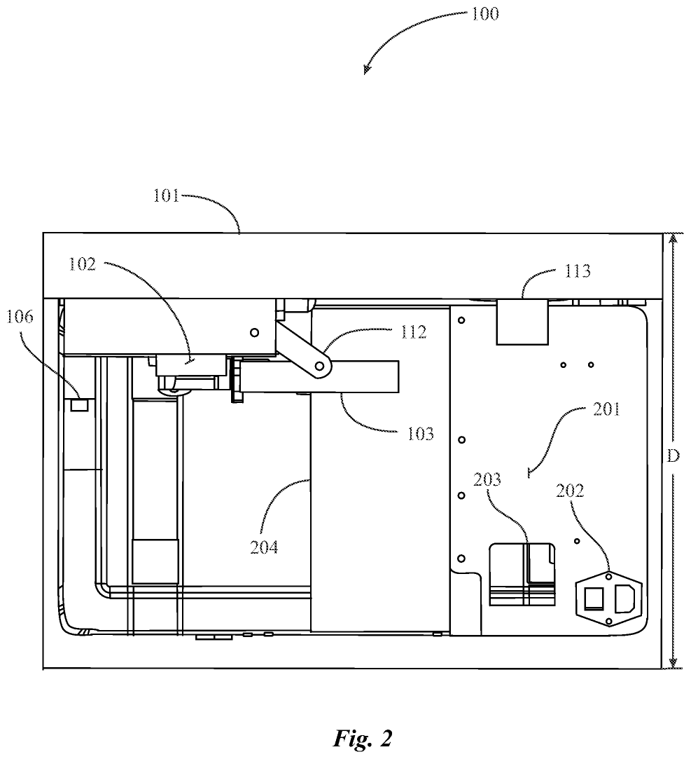

FIG. 2 is a top view of video production kit 100 of FIG. 1. In one embodiment case 101 includes at least two extendible/retractable legs (not visible) on the front side of the case so that it may be stabilized on a flat surface. Case 101 has a depth D from the front to rear of about 14 inches. In this embodiment, camera 102 is mounted on the head unit (not visible) of the tripod head mechanism 108. Tripod mechanism 108 may be operated to adjust camera height, camera angle, camera tilt, and the like (camera position). In one application, camera 102 may be a Black Magic™ pocket cinema camera that may be controlled remotely through by a Black Magic™ Atem mini pro ISO. Such a device (not illustrated) may be referred to in the art as a switcher and is in the form of an electronic board with source inputs and video outputs including large visible input keys that an operator may use to switch between up to four 4 separate cameras (three additional cameras) while recording. In one embodiment, camera 102 may include a Panasonic™ Lumix camera lens with a focus range of 20m. In this embodiment, display monitor 103 may be a Ninja display monitor capable of 4K video resolution in display.

Camera 102 mounts to the head of tripod head mechanism 108 as described further above. Monitor 103 may be mounted to camera 102 via a horizontal swivel boom arm 112. Monitor 103 may, in one embodiment, be removed from boom arm 112 and the monitor may be adjusted for viewing angle and tilt. The spatial arrangement between camera 102 and monitor 103 has the monitor right next to the camera at the same level of the camera. This is a preferred arrangement for convenience of the operator or presenter and for a remote crew member or members that may view what the camera sees remotely on their monitor or monitors.

Video production kit 100 includes a compartment in the bottom right portion of the case bottom of case 101. The compartment has a depth and width and height sufficient to house required electronics components that enable the kit, for example to connect to the Internet and be remotely accessible and controllable through the Internet from a remote station on the network. A compartment cover plate 201 is provided to cover and protect the internal electronic components within the compartment. Cover plate 201 may be a lightweight metal such as sheet metal, aluminum, or some other rigid plate material.

In this embodiment, cover plate 201 is machined to produce a view window 203 for providing access to internal components without removing the cover plate and to provide ventilation for running electrical and or computing components. Cover plate 201 also supports a power switch 202 with a port for accepting an Ethernet network cable. Production kit 100 includes a video switch panel 204 that forms one side of the lower compartment housing the electronics and connects to cover plate 201. The compartment space may take up about one third of the volume in the case bottom.

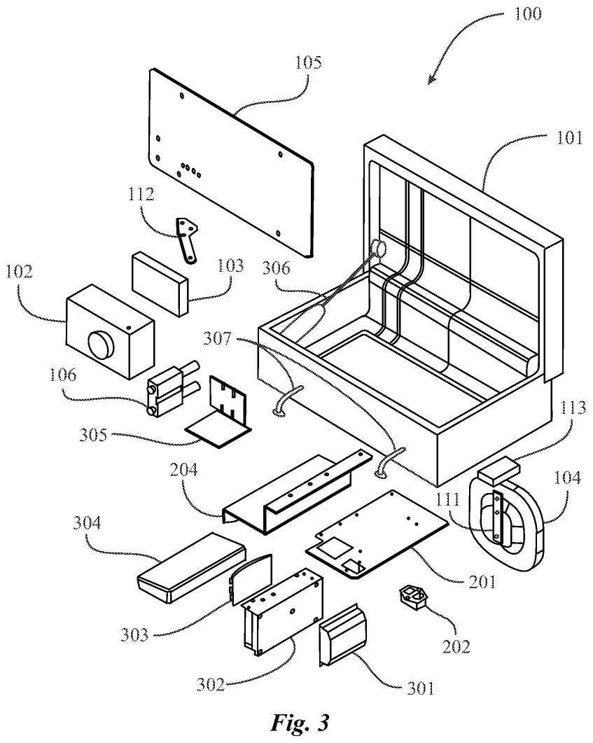

FIG. 3 is a disassembled view of video production kit 100 of FIG. 1 depicting basic components. In this view, components are removed from case 101 for identification. In one embodiment, cases 101 includes a gas strut 306 installed to the inside side wall of the case top at one end and to the inside of the front wall of the case bottom to help stabilize the position of the case top when production kit 100 is open for a video production session. Gas strut 306 may be deployed to hold the case lid of case 101 upright for use. One with skill in the art will agree that other case strengthening or case adjusting mechanisms may be used in place of strut 306 such as a fixture, a tightening screw assembly, a position lockable hinge unit etc. to ensure the case lid may be stabilized in the upright position and at a desired angle while the case is prevented from closing when the production kit is being used.

In this embodiment, video production kit components include rectangular top mounting plate 105. Plate 105 fits into the back of the lid of case 101. Plate 105 may be mounted to the inside surface of the lid back panel using a glue, screws, or other mounting hardware. Production kit 100 includes camera 102, video monitor 103, and mounting boom arm 112 that connects the monitor to the camera. In one embodiment camera 102 is a Blackmagic™ Pocket Cinema Camera 4K. In one embodiment, monitor 103 is a Ninja™ display monitor capable of 4K video resolution. Production kit 100 includes audio controller 106. Controller 106 may connect to camera audio may be a sound adapter referenced herein as Cinema adapter for camera audio. In one embodiment, controller 106 is a Beachtek™ DXA_ReD audio mixer connected to the camera.

Video production kit 100 includes a rear case support piece 305. Case support 305 may be a metal bracket support used in place of, or in addition to gas shock 306 provide rigidity to the case lid open position. In one embodiment, video production kit 100 includes at least two stabilizing legs 307. Legs 307 may be retracted from the case bottom front side and set to contact the table surface to stabilize case 101 from sliding, shaking, rocking, etc. Production kit 100 includes cover plate 201 and video switch panel 204 forming a compartment housing the electrical components of the kit. Video production kit 100 includes lighting source 104, folding bracket 111 and swivel 113 grouped to the right of case 101. Switch housing 202 is depicted next to cover plate 201, which includes a rectangular opening provided there through to accept the switch housing. Housing 202 includes the Ethernet port for accepting an Ethernet cable.

Video production kit 100 includes a power supply 302 for regulating power to the kit from an electrical outlet (three prong cable). In one embodiment, power supply 302 is a Meanswell™ ADS 155122 channel 12v/5v. Video production kit 100 includes a computer processing unit (CPU) 303. CPU 303 is adapted in a preferred embodiment for Bluetooth™, WiFi/MiFi™ (created mobile 3G to 5G hot spot), and Ethernet communication. CPU 303 may be a single board minicomputer using Intel core technology with processing speeds up to 4 GHz. CPU 303 may contain up to 8 Gigabytes or more of memory space. CPU 303 may be adapted with a graphics processor such as an Intel™ UHD Graphics 615 processor or equivalent. In one embodiment, CPU 303 is a Latte Panda™ Alpha 864. In a preferred embodiment CPU 303 is provided to operate production kit 100 and to enable control of certain features of the production kit via Ethernet access or Wi-Fi access from a remote network address using a remote access and control application. A mini-computer such as mini-computer 303 is, in a preferred embodiment, a boot able computer drive and may include a mini mouse and mini keyboard (not visible) for operator interface and input using the production kit monitor 103 or another connected monitor as a display.

CPU 303 includes a modem and port for connection to a wide area network (WAN) such as the Internet network and may similarly include a wireless modem functioning as a Wireless Fidelity (Wi-Fi) hot spot for wireless access to the network when Ethernet cabling is not practical or not available. CPU 303 supports all of the features of production kit 100 including camera, microphones, monitor, lighting, and switching utility. A remote crew or individual may access all of the features of production kit 100 through access to CPU 303 from a remote system control domain on the network. CPU 303 may include ports for Ethernet, USB, audio, and HDMI supporting the features of the camera, and any other similar ports known to those of skill in the art.

In this embodiment, production kit 100 includes a network modem/data router 301. Router 301 is adapted for Internet access and communications between a remote crew and an operator of the production kit. In one embodiment, router 301 is a Peplink™Max BR1 Mini Core 4G LTE/3G fall back router (RTR). In one embodiment, router 301 is a Pepwave™ router capable of generating a wireless hot spot and capable of hosting two separate wireless communications carriers simultaneously, for example, ATT and Verizon. Video production kit 100 includes a video switcher unit 304. Video switch unit 304 may connect to the video switch panel 204. This device is referred to as a switcher and is in the form of a board with source inputs and video outputs including large visible keys that an operator may use to switch between 4 camera sources (three additional cameras) while recording. Switcher 304 may be software-controlled from a remote network address for selectively switching from one input to another input of the production kit for record, display, streaming, etc.

Switching unit 304 may include an Ethernet port and may be accessed and controlled remotely over a data network. In this embodiment, switching unit 304 may be connected to CPU 303 on production kit 100 and may be controlled through remote access to CPU 303. Switcher 304 may have inputs for up to four cameras and at least two audio microphones. In general features of production kit 100 may be controlled by an advanced technology in experimental mechanics (ATEM) software control panel enabling remote control of camera aspects, audio aspects, effects, etc. through the switcher 304. Control of CPU 303 may be achieved through a desktop style remote control SW (or other similar remote-control applications) by permission of the client. Settings for at least one lighting source may be controlled through the computing module accessed remotely using an application known as ‘Elgato’ for producing lighting effects, adjustments, or some other lighting control SW.

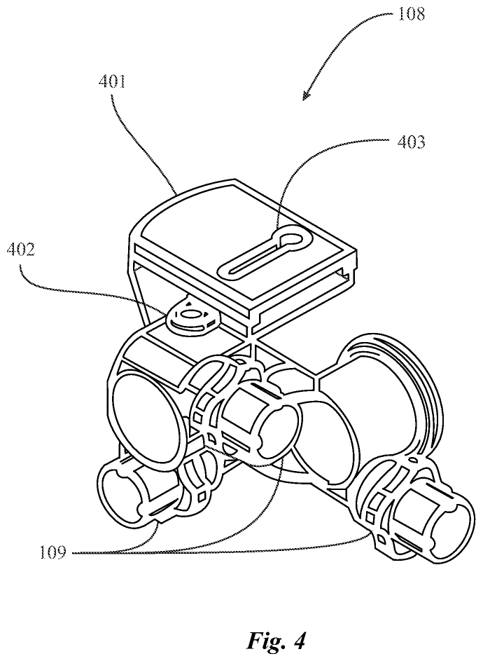

FIG. 4 is a perspective view of tripod head assembly 108 of the video production kit of FIG. 1. Tripod head assembly 108 is adapted to adjust camera tilt, camera angle, and pan of camera 102. Tripod head assembly 108 includes three simple mechanical turn knobs 109 enabling an operator to adjust camera position (orientation) along an x, y, and z axis. Tripod head assembly 108 includes a platform or head piece 401. Head piece 401 is connected to the tripod via a connector arm piece 402. The camera 102 may be mounted to the head piece 401 at a camera mounting slot 403.

In one embodiment, tripod head assembly 108 is mounted to the top mounting plate 105. Display monitor 103 is mounted to the right side of the camera in close proximity to the camera. An operator may operate tripod head assembly 108 by turning knobs 109 individually back and forth while the monitor is set to display what the camera lens captures. In this way, the camera may be adjusted to properly frame the subject of camera view. In one embodiment, a camera attached to head piece 401 may be moved back or brought forward on the head piece via manual camera mount positioning at slot 403. In an alternative embodiment, tripod head assembly 108 may include a telescopic arm oriented vertically in the tripod body mechanics and may allow the operator to extend the position of the mounted camera above the top edge of the case lid of case 101 in the open position.

In an alternative embodiment, tripod head assembly 108 may be adapted with electronically controlled servomotors for controlling each turn knob 109 by electronic command. In such as embodiment, a remote crew operator may access tripod head assembly 108 while receiving the camera view and may adjust for tilt, angle, and pan remotely.

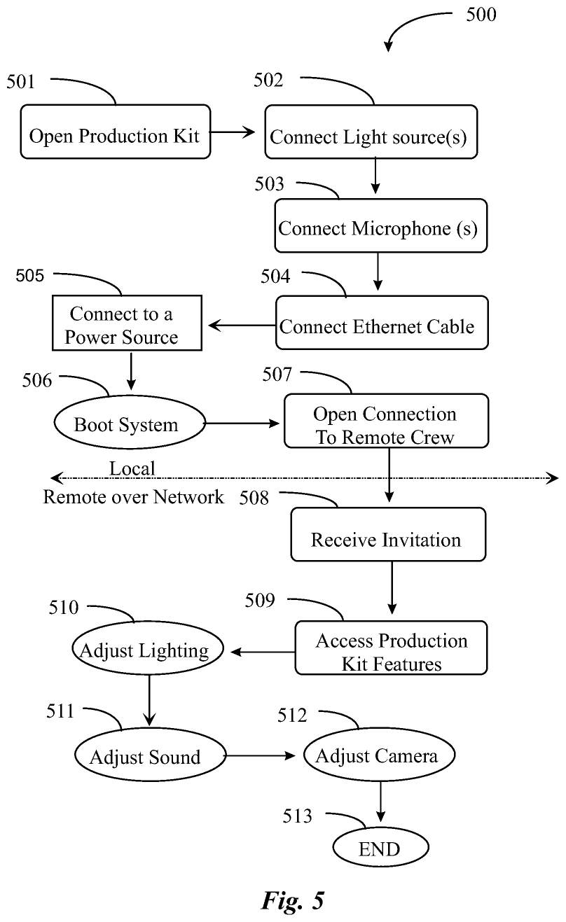

FIG. 5 is a process flow chart 500 depicting steps for remotely assisting a video production using the video production kit of FIG. 1. In general use of the video production kit of the present invention, an operator may acquire assistance from a remote crew at any time during set up and active sessions. At step 501, an operator may open the production kit analogous to kit 100 of FIG. 1. The operator may place the production kit in an open position on a table, for example, to record a video shoot. At step 502, the operator may position the primary light source and may (if needed) connect additional lighting accessories to the case structure (101) of the production kit plugging them into appropriate electrical ports. In one embodiment, up to three light sources may be attached to the case of the production kit. In one embodiment, an additional light source may include a floor stand or tabletop stand mounted light source adapted to sit on a floor, table, or other surface next to the production kit.

At step 503, the operator may connect (plug-in) one or more microphones into the production kit. In one embodiment, there may be a resident microphone that is mounted to the production kit mounting plate 105, and one or more accessory microphones that may be worn (LAV mics) or may be placed on a table near a subject of the video shoot. At step 504, the operator may connect an Ethernet cable to the video production kit for accessing the Internet. In the event of no Ethernet, a Wi-Fi modem may be used instead to access the Internet via Ethernet. If Ethernet service is not available on location, the operator may alternatively use a Wi-Fi/MiFi (created mobile 3G to 5G hot spot), through one of two communications carriers mentioned further above.

At step 505, the operator may connect the production kit to power and may, in one embodiment physically boot the system at step 506 by depressing a button on the switch housing (202). In another embodiment, a rechargeable battery might be provided as well as a power adapter so that the production kit may be operated in a location with no available power source outlet. The production kit may, in one embodiment, automatically forge a network connection to a remote crew domain at step 507 by default once the system is booted up. In one embodiment, an operator may get an Internet screen on monitor (103) with options to connect to a remote crew agent. Steps 501 through 507 occur locally at the site of the video production shoot. The remaining steps may be performed remotely by at least one remote crew member.

At step 508, the remote crew domain or Website receives a request from the user at the start of a video production event. In one embodiment, a video production event may be scheduled by the operator with the remote crew. The remote crew site anticipates the schedule or sends notification of the scheduled event to the operator. In other embodiments, the remote crew may receive requests automatically, may help remotely on demand or help whenever the operator wishes to shoot video.

At step 509, one or more remote crew members may gain control of the video production kit features. During this step, a remote crew member may appear on the connected monitor 103 and greet the operator before beginning assistance. The remote crew member may adjust lighting at step 510, sound at step 511, and camera/effects at step 512. In one embodiment, a remote crew member connected to and having control of the production kit may communicate general suggestions to the user through the production kit monitor: which lighting sources to use, how may microphones to plug-in, and what further adjustments might be required to level or angle the camera using the tripod mechanism until either the operator or the remote crew disconnect at END 513.

It is noted herein that the remote crew domain may receive live feed from the production unit once filming and recording are underway and may direct feeds to destination devices or systems or distribution points, broadcast feeds from the remote crew domain, edit feeds stored or cached, cache feeds for a later airtime, and so on.

In one embodiment, general use regarding set up and pack out include sub-steps not mentioned in the more abstract process of FIG. 5. In this process the operator stabilizes the video production kit on a flat surface such as a table before opening the kit wherein the kit includes stabilization feet that may be extended from the case body (101) to prevent sliding or rocking of the kit. Powering the production kit may be the first step after the kit is open on a table. After power, the operator may plug in the Ethernet cable/power on the hot spot router to gain Internet access.

The operator may then power on the camera and remove the camera lens cap. The operator may then power on the monitor (103), unfold and position the light source (104), set up the microphone including table mics and garment mics. (h) Position a button microphone on table in front of your position; and (I) Clip on a Lavalier microphone on lapel or similar garment piece. Cables, mikes, headphones, mouse, keyboard, case clips for clipping additional lighting sources to the case, and other accessories may be stowed inside case 101 after a video production shoot is over and the operator breaks down the production kit before closing and latching the case 101.

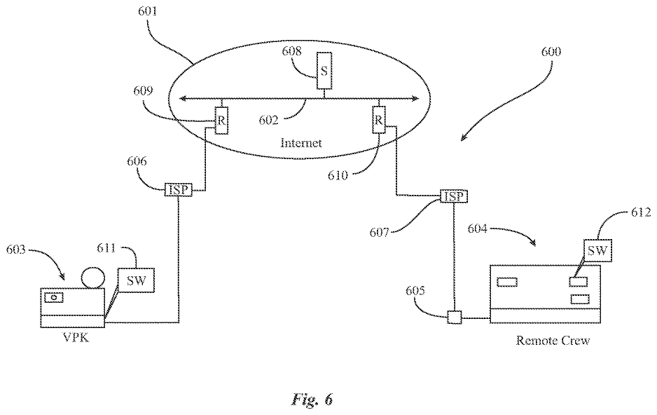

FIG. 6 is an architectural view 600 of a network bridging the video production kit of FIG. 1 to a remote crew controlling interface. View 600 represents a logical network connectivity between a video production kit 603 analogous to video production kit 100 of FIG. 1, and a remote crew operator station 604. A wide area network (WAN) such as the Internet network 601 may be the primary carrier network for interaction between VPK 603 and remote crew station 604. Internet 601 is further defined by an Internet backbone 602. Internet backbone 602 may represent all of the lines, equipment, and access points that make up the Internet as a whole including any connected sub-networks wireless or wired.

Video production kit 603 may connect to Internet backbone 602 through an Internet access line such as Ethernet cable to an Internet service provider (ISP) 606 and a network router (R) 609. Remote crew station 604 may connect to Internet backbone 602 through a local area network (LAN) router 605, an Internet access line to an ISP 607 and through a network router (R) 610. Remote crew station 604 may be one of many stations available on a network domain whereby requests from video production operators may be routed to individual remote crew agents. In one embodiment, VPK 603 may connect to Internet 601/backbone 602 via wireless service through Wi-Fi/MiFi. Also in this embodiment, remote crew station 604 may also be wireless connected and mobile in some cases.

In a preferred embodiment, an operator of video production kit 603 may be provided with the remote crew service from station 604, which an operator may subscribe to as a service when they purchase the kit. The VPK operator may elect to receive on demand and scheduled online assistance with video production tasks, including making minor camera adjustments, making sound quality adjustments, making lighting adjustments, creating and running teleprompter materials, switching video feeds and microphone switching (more than one microphone), green screen operations for video (background dressing), video streaming (publication, live stream), video broadcast (scheduled, live), video editing/synchronizing, and recording to drive space for later scheduled editing and publication. In a preferred embodiment, the remote crew member receives a bird's eye view of what the video production camera 100 sees when it is turned on and connected. Also, in a preferred embodiment, the online interaction between the remote crew member and the local camera operator over network backbone 602 may include seamless bidirectional voice communications and video communications the assisting crew member displayed on monitor 103 and the exact likeness of the local operator or talent subject may be displayed at the remote crew office.

In this embodiment, backbone 602 supports a server (S) 608. Server 608 may represent a communications and data server that may be adapted to broker interaction between the video production kit operator and the remote crew station operator. Video production kit 603 may include software (SW) 611. SW 611 may represent any SW programs or instruction for supporting different features of the video production kit including Bluetooth, ATEM mini-ISO pro switcher 304, and the SW associated with CPU 303 such as Windows™ 10 including support for Wi-Fi and Bluetooth™.

Remote crew station 604 may include software (SW) 612. SW 612 may represent SW programs used to control and interact with video production kit 603 remotely including Blackmagic Atem control SW for controlling the camera function, Audacity audio control and editing SW for audio monitoring, and El Gato 4K capture SW for streaming live video. Features of VPK 603 may include 4K Blackmagic RAW recording output; two recording modes for the camera (4K RAW and 1080P H.264); 4:2:2 12-bit color space; controller inputs for up to 4 cameras; Switching ability for three connected video sources in addition to the main camera; ability for full live streaming mode; ability for live green screen recording; and plug-n-play operation. In a variation to the embodiment, Sony™ Imaging Edge™ may be provided as part of SW 612 for controlling the camera function. Features include ultra-high 4:2:2 16 bit Pores RAW for better color; three simultaneous 4K recording and one for Pores RAW, 2.4K XAVS; two simultaneous audio recording devices; and a two button start interface. In one embodiment noted features of video production kit 603 may include an additional audio recording device Atomos™ Ninja V; a camera Sony™ 35 mm F2.8 or Sony™ 50 mm F1.8; a mini-CPU Latte Panda Alpha 864; Lighting Elgato key light Air; Internet solution: Peplink™ Max Mini or Peplink™ Wave: Audio Mixer: Beachtek™ DXA ReD; Lay Microphone: Sanken™ COS 11; Button Microphone: Sanken™ CFUB 1; and an AC Power Board.

Remote crew station 604 may be a computing device like a desktop system or a laptop computer with display. Boxes depicted on display may represent various sundry control panels for adjusting and monitoring sound or video. Control panels spawned on screen may include sound controls and sliders provided for each audio input accessed. One SW feature of remote crew station SW 611 may be the presence of a teleprompter feature that may be taken over remotely and controlled by a remote crew member in real time to serve timely prompts in real time to talent on camera and using viewing monitor 103 to deliver. For example, a remote crew member may create prompts, may switch prompts, and may reduce or increase prompter speed (automated scrolling). In one embodiment, remote crew member may help create all of the prompting for a video production that may be scheduled with a remote crew assistant.

It will be apparent with skill in the art that the video production kit of the present invention may be provided using some or all the elements described herein. The arrangement of elements and functionality thereof relative to the video production kit of the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. A modular video production kit remotely controllable over a data network comprising:
a hinged case having a case bottom, a case top, a case handle, and a case latch operable to open and close the case, the case bottom and case top each having an internal volume defined by a length dimension, a width dimension, and a depth dimension;
a video production camera mounted to a tripod head assembly, in turn mounted to a mounting plate secured against the back wall of the case top;
a video monitor mounted to the video production camera by an extension boom arm;
a computer processing unit (CPU) disposed within the case bottom within a compartment provided therein for the purpose;
a production light source mounted to the mounting plate against the back wall of the case top;
at least one microphone connected to an audio input port;
at least one network modem connected to the CPU; and
a power supply disposed within the compartment formed in the case bottom, the power supply including a power on power off switch;
characterized in that a remote network-connected service may by invitation request from an operator of the modular video production kit, access the modular video production kit over the data network, communicate with the operator of the modular video production kit, make remote adjustments to electronic components of the modular video production kit in set up and in use, and may receive video and audio recorded from the modular video production kit for the purpose of remote processing and publishing.

2. The modular video production kit of claim 1 further including an electronic switcher board connected to the CPU, the switcher board having multiple camera source inputs and video feed outputs and having operable function keys for controlling switching between the multiple camera sources while recording.

3. The modular video production kit of claim 1, wherein the video monitor is adapted to function as a user interface device for interaction with a remote individual or a remote crew when the operator has the camera powered on and is connected to the data network.

4. The modular video production kit of claim 1, further including a gas strut mounted to a sidewall of the case top at one end and to the front sidewall on the case bottom at the other end, the gas strut adapted to hold the hinged case open at a desired angle.

5. The modular video production kit of claim 1, further including one or more hinge locks adapted to hold the hinged case open at a desired angle.

6. The modular video production kit of claim 1, further including a rechargeable battery.

7. The modular video production kit of claim 1, wherein the power supply is plugged into an alternating current (AC) outlet for power.

8. The modular video production kit of claim 1, wherein the modem is adapted as a wireless modem having access to the data network through a wireless network and wherein the data network accessed is the Internet network.

9. The modular video production kit of claim 1, further including an Ethernet port and cable for accessing the data network via an Ethernet network connection.

10. The modular video production kit of claim 9, further including a portable wireless router for creating a WiFi hotspot through which the data network may be accessed.

11. The modular video production kit of claim 1, wherein the tripod head assembly includes three operable knobs for adjusting camera position relative to at least tilt, angle, and pan, the knobs controlling the head component of the assembly adapted as a mounting platform for the video production camera.

12. The modular video production kit of claim 1, wherein the at least one microphone is a high impedance unidirectional microphone.

13. The modular video production kit of claim 1, wherein the at least one microphone is high impedance omnidirectional microphone.

14. The modular video production kit of claim 1, further including a cinema adapter for mixing camera audio from a remote location on the network.

15. The modular video production kit of claim 1, further including at least two extendable stabilization legs installed in the case bottom and adapted to be extended and locked to stabilize the hinged case on a flat surface.

16. The modular video production kit of claim 1, wherein communications between the remote crew and camera operator over the data network are brokered by a communications server connected to the data network.

17. The modular video production kit of claim 1, wherein remote assistance is provided through a subscription service on demand or by schedule.

18. The modular video production kit of claim 16, wherein the act of connecting the production kit to the data network results in a request sent for remote assistance that is, by default, routed to a remote service agent station according to agent availability.

19. The video production kit of claim 1, wherein the video production created with assistance from a remote agent is recorded to a memory drive on the video production kit for later publication through the remote service that provided the remote assistance.

20. The video production kit of claim 1, wherein the video production created with assistance from a remote agent is streamed live to a publication channel through the remote service providing the remote assistance.
